(19) United States
(12) Patent Application Publication
(10) Pub. No.: US 2026/0015021 A1
(43) Pub. Date: Jan. 15, 2026

(54) Jackstand Having Cantilever Spring Mechanism

(71) Applicant: Robert Bosch GmbH, Stuttgart (DE)

(72) Inventor: Daniel Newkirk, Owatanna, MN (US)

(21) Appl. No.: 18/771,156

(22) Filed: Jul. 12, 2024

(51) Int. Cl. B62B 3/02; B66F 5/00

(52) U.S. Cl. CPC B62B 3/02; B66F 5/00

(57) ABSTRACT

A cart suitable to support an automotive jackstand via a shelf, the shelf supported by a number of wheels coupled to the shelf using a cantilever. The cantilever exhibits elastic behavior in response to loads received by the shelf. In one embodiment, the cantilevers exhibit elastic behavior via a joint. In another embodiment, the cantilevers exhibit elastic behavior via a spring bolt.

### TECHNICAL FIELD

This disclosure relates to hand tools. More specifically, this disclosure is related to hand tools for use in automotive repair shops.

### BACKGROUND

Jackstands are used to prop up automobiles during service. Because automobiles can be quite heavy, jackstands need to be robust to support a large amount of weight. Existing jackstands can be heavy to move by hand and require a user to lift from a suboptimal ergonomic posture.

What is desired is a jackstand that can be placed easily, accurately, and ergonomically without affecting the stability or capacity of the jackstand.

### SUMMARY

One aspect of this disclosure is directed to a cart comprising a shelf, a cantilever, and a wheel. The shelf has a top surface and a bottom surface, the top surface configured to receive a load and the bottom surface being disposed at a clearance distance over terrain surface supporting the cart. The cantilever has a proximal end and a distal end, the proximal end coupled to the shelf. The wheel is coupled to the cantilever at the distal end. The shelf transfers a received load to the wheel via the cantilever. The cantilever elastically deforms when subjected to the received load such that the clearance distance is correlated to the received load, wherein the clearance distance is maximized under zero load and the clearance distance is minimized when the load is greater than a threshold load value. The bottom surface is in contact with the terrain surface when the clearance distance is minimized. Some embodiments may comprise a plurality of cantilevers. Some embodiments may comprise a plurality of wheels.

Another aspect of this disclosure is directed to a cart comprising a shelf, a cantilever, and a wheel. The shelf has a top surface and a bottom surface, the top surface configured to receive a load and the bottom surface being disposed at a clearance distance over a terrain surface supporting the cart. The cantilever has a proximal end and a distal end, the proximal end coupled to the shelf via a spring-loaded hinge. The wheel is coupled to the cantilever at the distal end. The shelf transfers a received load to the wheel via the cantilever, wherein the spring-loaded hinge compresses when subjected to a received load such that the clearance distance is correlated to the received load. The clearance distance is maximized under zero load and the clearance distance is minimized when the load is greater than a threshold load value. The bottom surface is in contact with the terrain surface when the clearance distance is minimized. Some embodiments may comprise a plurality of cantilevers. Some embodiments may comprise a plurality of wheels.

The above aspects of this disclosure and other aspects will be explained in greater detail below with reference to the attached drawings.

### BRIEF DESCRIPTION OF THE DRAWINGS

FIG. 1 is an illustration of an automotive jackstand.

FIG. 2 is an illustration of a cart with a first cantilever.

FIG. 3 is a close-up illustration of the first cantilever of the cart of FIG. 2.

FIG. 4 is an illustration of a cart loaded with a jackstand.

FIG. 5 is an illustration of a cart loaded with a jackstand and with additional load force.

FIG. 6 is an illustration of a cart having a second cantilever.

FIG. 7 is a clow-up illustration of the second cantilever of the cart of FIG. 6.

FIG. 8 is an illustration of a cart loaded with a jackstand.

FIG. 9 in an illustration of a cart loaded with a jackstand and with additional load force.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

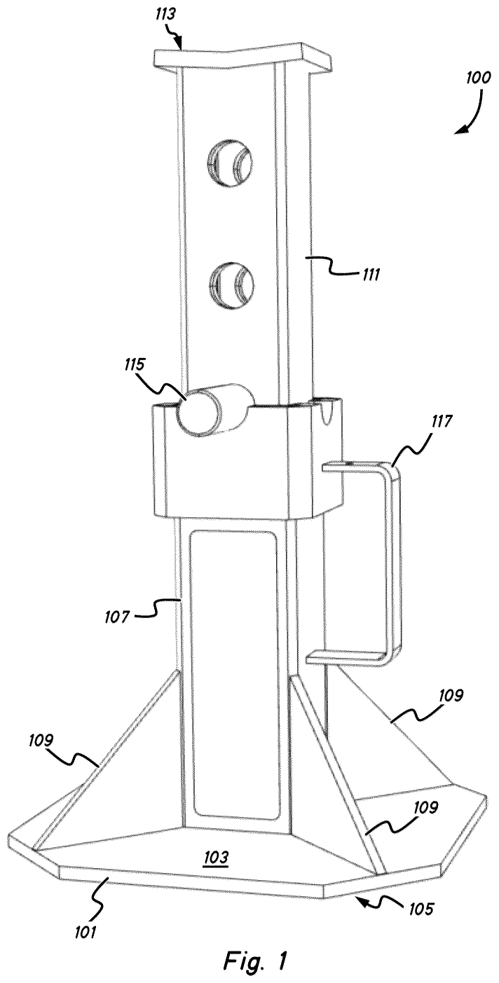

FIG. 1 is a depiction of a jackstand 100. Jackstand 100 comprises a base member 101 having a top surface 103 and a bottom surface 105. Projecting from the top surface 103 is a sleeve 107 supported by a number of sleeve supports 109. Extending from sleeve 107 is a support arm 111 having a support surface 113 that is configured to receive a load, such as from the frame of an automobile (not pictured). The extension of support arm 111 is fixed using a locking mechanism 115. In the depicted embodiment, the locking mechanism 115 comprises a peg lock, but other embodiments may comprise other configurations without deviating from the teachings disclosed herein. By way of example, and not limitation, such embodiments may comprise a ratchet lock, a vice lock, a latch lock, a channel lock, or any other locking mechanism known to one of ordinary skill in the art without deviating from the teachings disclosed herein. In the depicted embodiment, jackstand 100 further comprises a handle 117 which may be utilized by a user to move, position, or carry the jackstand 100. Some embodiments may not comprise a handle 117 without deviating from the teachings disclosed herein.

Jackstand 100 exhibits a set of characteristics that make it suitable for use with automotive vehicle loads. By way of example, and not limitation, jackstand 100 may be specified to support up to 20 tons of force as received by support surface 113, but other embodiments may comprise a different maximum load without deviating from the teachings disclosed herein.

The self-mass of jackstand 100 influences its total maximum capacity, with larger and heavier configurations being capable of supporting higher loads. In some embodiments, jackstand 100 may itself weight between 25-50 pounds when not subject to any external load. In the depicted embodiment, jackstand 100 weighs 45 pounds, but other embodiments may comprise other weights without deviating from the teachings disclosed herein.

The dimensions of base member 103 will additionally influence the performance of jackstand 100, with larger dimensions providing a wider and more stable support for received loads. In the depicted embodiment, base member 103 comprises a cropped rectangle shape, having 4 large sides (similar to a rectangle) and 4 short sides, creating an irregular octagon, but other embodiments may comprise different shapes and sizes without deviating from the teachings disclosed herein. By way of example, and not limitation, the total length of each dimension of base member 103 may be between 10-16 inches long without deviating from the teachings disclosed herein. In the depicted embodiment, the total area of base member 103 will fit within a 15.5-inch by 15.5-inch square, but other embodiments may comprise other configurations. In some such embodiments, base member 103 may fit within an 11-inch by 11-inch square without deviating from the teachings disclosed herein.

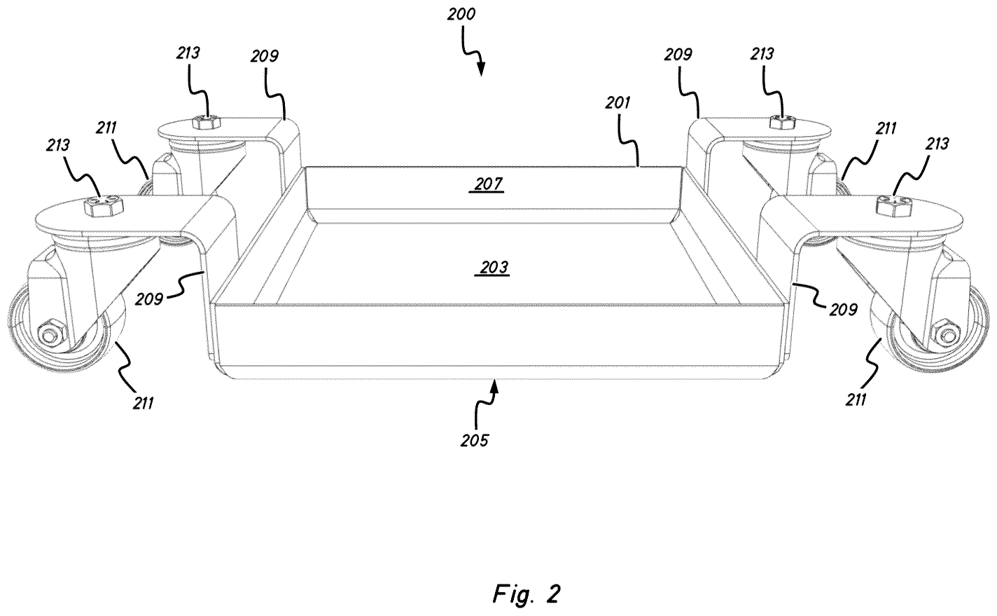

FIG. 2 is an illustration of a cart 200 suitable for use with jackstand 100 (not pictured; see FIG. 1). Cart 200 comprises a shelf 201 having a top surface 203 and bottom surface 205. Top surface 203 is suitable to receive an external load, such as the weight of a jackstand (such as jackstand 100; see FIG. 1). By way of example, and not limitation, the area of top surface 203 may be defined by a first and second dimension, corresponding to a length and width of top surface 203 (or vice-versa). Each of the dimensions being 10 to 16 inches long without deviating from the teachings disclosed herein. In the depicted embodiment, a 16-inch by 16-inch square may accommodate a jackstand 100 having a base member 103 (see FIG. 1) having a 15.5-inch by 15.5-inch measurement, but other embodiments may comprise other dimensions without deviating from the teachings disclosed herein.

Shelf 201 is supported by a number of cantilevers 209 coupled to shelf 201, each cantilever 209 having a wheel 211 coupled to it. Each wheel 211 is coupled to its associated cantilever 209 utilizing a stem 213. In the depicted embodiment, wheels 211 comprise a caster that can rotate about an axis defined by stem 213, but other embodiments may comprise other configurations without deviating from the teachings disclosed herein. In the depicted embodiment, each of wheels 211 freely rotates about an axis (not shown), but in some embodiments one or more wheels 211 may comprise a brake or lock mechanism to prevent free rotation when engaged without deviating from the teachings disclosed herein.

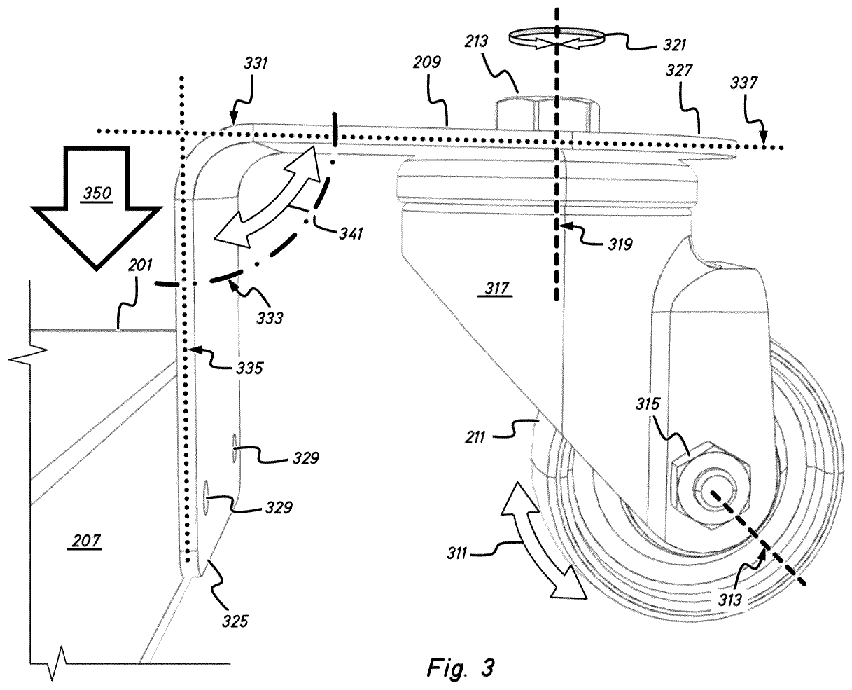

FIG. 3 is a close-up illustration of one of cantilevers 209 and its associated wheel 211, showing additional features of each. Wheel 211 rotates along a rotational direction 311, about an axis 313, defined by an axle 315. Axle 315 is disposed between surfaces of a shell 317, and shell 317 is a coupling mechanism between wheel 211 and stem 213. Shell 317 and wheel 211 additionally form a caster assembly that is rotatable about an axis 319 defined by stem 213 along a rotational direction 321. Some embodiments of wheel 211 may not form a caster without deviating from the teachings disclosed herein.

Cantilever 209 comprises a proximal end 325 and a distal end 327 and is coupled to shelf 201 near the proximal end 325. In the depicted embodiment, cantilever 209 is coupled to shelf 201 using a number of fasteners 329 such as bolts, screws, or rivets, but other embodiments may comprise a different coupling mechanism without deviating from the teachings disclosed herein. In such embodiments, the coupling of cantilever 209 to shelf 201 is achieved near the proximal end 325, but other embodiments may comprise other configurations without deviating from the teachings disclosed herein. In some embodiments, the coupling of cantilever 209 and shelf 201 may not be achieved using fasteners 329, but may instead be accomplished via other means such as a weld, an integration joint, a clip mechanism, or an interlocking mechanism without deviating from the teachings disclosed herein.

Cantilever 209 is configured to transfer a load received by shelf 201 onto wheel 211 up to a threshold load value. For loads below the threshold load value, cantilever 209 will exhibit elastic deformation, returning to its original shape once the load is removed. The elastic deformation is exhibited by cantilever 209 by a joint 331, which is formed by an intersection of the proximal end 325 and the distal end 327. An angle 333 of joint 331 is defined by an intersection of linear dimensions of proximal end 325 and distal end 327. A proximal linear dimension 335 is defined by the length of proximal end 325, and a distal linear dimension 337 is defined by the length of distal end 327. Angle 333 opens/widens or narrows/closes along an angular direction 341 in a variable corresponding response to an external load 350. The maximum width of angle 333 is exhibited when external load 350 is equivalent to the threshold load value, and the minimum width of angle 333 is exhibited when the external load 350 is zero. In the depicted embodiment, the maximum width of angle 333 is a right angle, but other embodiments may comprise a different maximum angle without deviating from the teachings disclosed herein. For the purposes of this disclosure, a “right” angle is defined as 90-degrees within a manufacturing tolerance recognized by one of ordinary skill. By way of example, and not limitation, the threshold load value for cart 200 may be in the range of 40 to 60 pounds, and the threshold load value of each cantilever 209 may be in the range of 10 to 15 pounds without deviating from the teachings disclosed herein.

This elasticity enables each of cantilevers 209 (see FIG. 2) to bear some of external load 305 up to the threshold load value, and changes the configuration of cart 200 (see FIG. 2) overall in response to an external load.

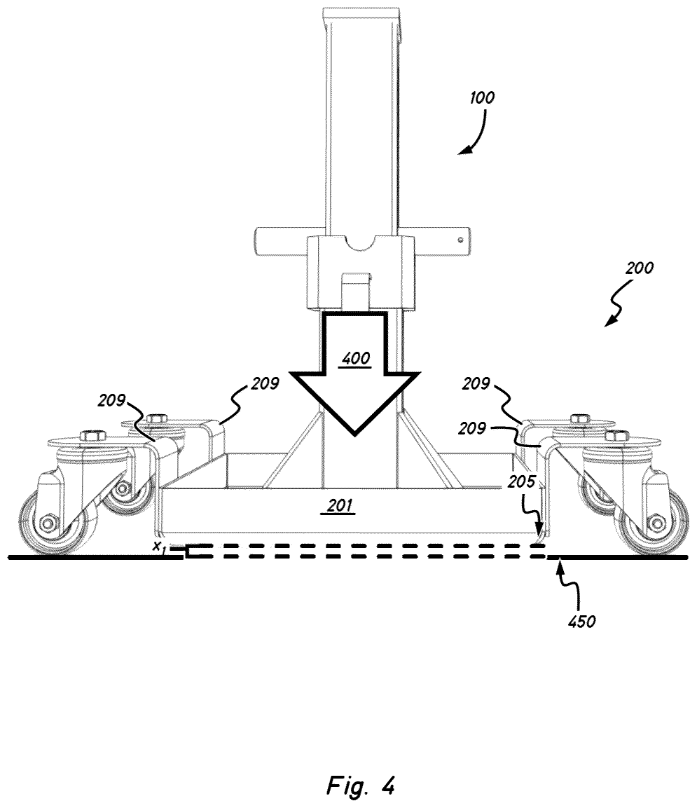

FIG. 4 is an illustration of cart 200 supporting jackstand 100. The weight of jackstand 100 applies a first load 400 to cart 200 that is received by shelf 201. Jackstand 100 is selected for its weight such that load 400 is less than the threshold load value of cart 200. As a result, there is a clearance distance x₁ between bottom surface 205 of cart 200 and the surface of the terrain 450 supporting cart 200. In the depicted embodiment, clearance distance x₁ is positive, but is not maximized. Clearance distance x₁ is maximized when cart 200 is subjected to zero external load. In response to loads greater than zero, shelf 201 lowers closer to terrain 450, and cantilevers 209 correspondingly elastically deform in response, resulting in a wider angle 333 (see FIG. 3). This elastic deformation can be advantageously utilized to stabilize cart 200 under sufficiently heavy loads.

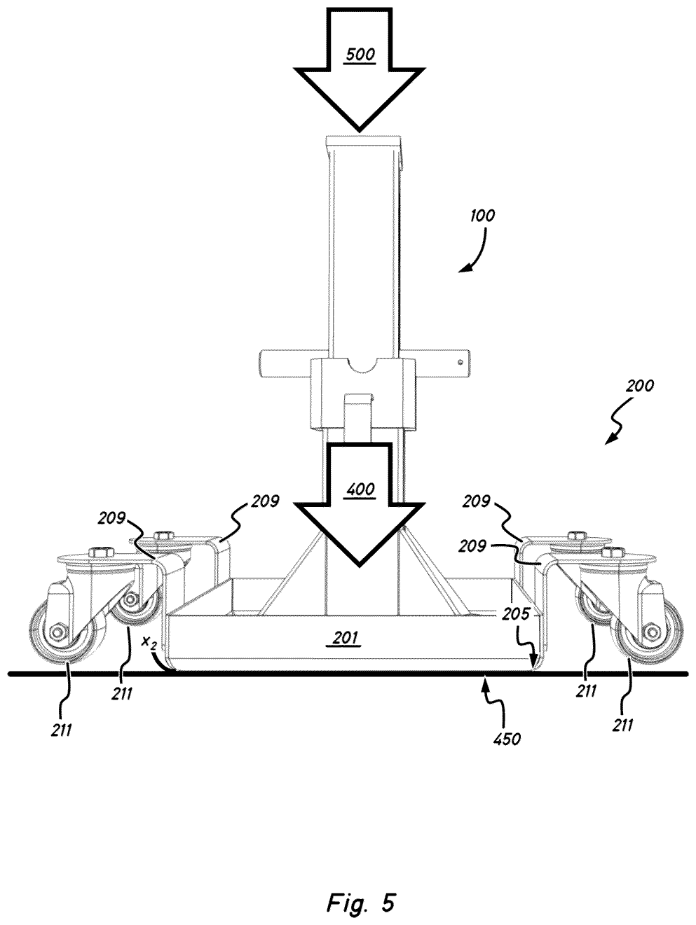

FIG. 5 is an illustration of jackstand 100 and cart 200 supporting an additional load 500, such as the weight provided by an automobile (not shown) via support surface 113 (see FIG. 1). In the depicted embodiment, the combination of the load 400 from the weight of the jackstand and the additional load 500 is greater than the threshold load value of cart 200. As a result, the shelf 201 drops such that bottom surface 205 comes in contact with terrain 450. Consequently, the clearance distance x₂ is reduced to zero, and also each cantilever 209 is exhibiting maximum deformation, and thus the angle 333 (see FIG. 3) of each cantilever 209 is maximally wide. In the depicted embodiment, this results in each of wheels 211 losing contact with terrain 450, though in other embodiments wheels 211 may instead only receive a minimum portion of the overall load without deviating from the teachings herein. In this condition, the bulk of the combined force of loads 400 and 500 received by shelf 201 and transferred directly to terrain 450 via bottom surface 205. This transfer of the bulk of the load protects the elasticity of each of cantilevers 209, which will thus advantageously not be subjected to loads that will plastically deform their shape. In this manner, once jackstand 100 is relieved of external load 500, the total load received by cart 200 will be under the threshold load value again, and cart 200 can advantageously be moved around using the wheels 211 again. This elasticity additional has the advantage of eliminating the ability of wheels 211 of moving during loads greater than the threshold load value for cart 200, and thus provides a secure and stable support of load 500 during the duration of time that the total lead exceeds the threshold load value. In the depicted embodiment, the threshold load value of cart 200 is selected to be only a small amount of force larger than load 400, thus only a small additional load is sufficient to cause the total load to be securely transferred to terrain 450 for safe operation of jackstand 100 while supported by cart 200.

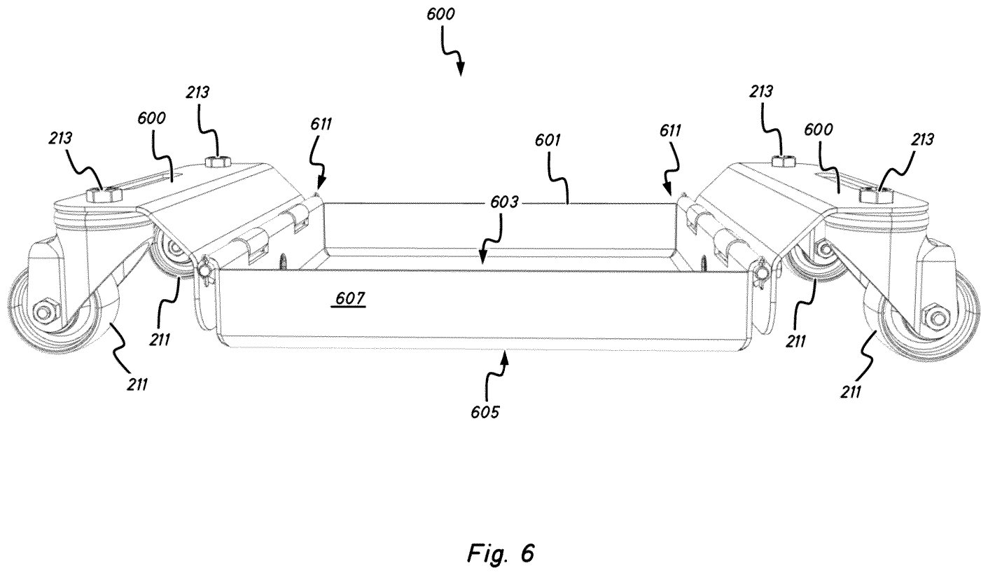

FIG. 6 is an illustration of a cart 600, an alternative embodiment of a cart suitable for use with jackstand 100 (not shown; see FIG. 1). Notably, cart 600 comprises a few identical features to cart 200 (see FIG. 2), in particular the wheels 211 and stems 213. Cart 600 additionally features a shelf 601 having a top surface 603, bottom surface 605, and retaining wall 607. Top surface 603 is suitable to receive an external load, such as the weight of a jackstand (such as jackstand 100; see FIG. 1). By way of example, and not limitation, the area of top surface 603 may be defined by a first and second dimension, corresponding to a length and width of top surface 603 (or vice-versa). Each of the dimensions being 10 to 16 inches long without deviating from the teachings disclosed herein. In the depicted embodiment, a 16-inch by 16-inch square may accommodate a jackstand 100 having a base member 103 (see FIG. 1) having a 15.5-inch by 15.5-inch measurement, but other embodiments may comprise other dimensions without deviating from the teachings disclosed herein.

While cart 600 additionally comprises a number of cantilevers 609, each of cantilevers 609 utilizes a hinge 611 to couple to shelf 601. In the depicted embodiment, each of cantilevers 609 is coupled two of wheels 211, but other embodiments may comprise a different number of wheels per cantilever, a different number of cantilevers, or a different number of wheels without deviating from the teachings disclosed herein. Some embodiments may comprise differently configured cantilevers (e.g., each cantilever being coupled to a different number of wheels) without deviating from the teachings disclosed herein. Additional differences between cart 600 and cart 200 will be made apparent in additional detailed disclosure.

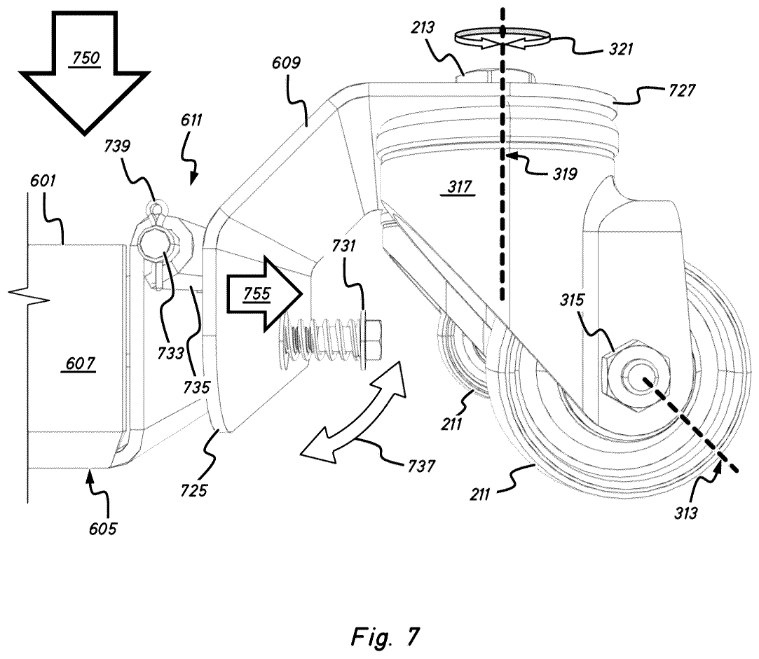

FIG. 7 is a close-up illustrations of one of cantilevers 609 and an associated wheel 211. Note that because wheel 211 is identical to previous embodiments, in this embodiment wheel 211 comprises the form and function of a caster as described previously in FIG. 3. However, cantilever 609 comprises distinctions from the previous embodiment. While cantilever 609 comprises a proximal end 727 disposed at an angel to a distal end 729, the shape of cantilever 609 is not elastically deformable. Instead, the elasticity of cantilever 609 is expressed using a spring of a spring bolt 731. Spring bolt 731 comprises the spring and a bolt, the spring engaging with proximal end 725 and the bolt coupling cantilever 609 to shelf 601 near the proximal end 727. Spring bolt 731 provides an elastic response to received loads by shelf 601 in conjunction with hinge 611. Hinge 611 comprises a hinge rod 733 disposed within a hinge bracket 735 along the length of hinge 611. Hinge 611 not only provides additional coupling between cantilever 609 and shelf 601, but also permits a rotational movement of cantilever 609 along a rotational direction 737 around a part of the circumference of hinge rod 733. This movement is dampened in an outward direction by elastic resistance from spring bolt 731 and limited in the inward direction by proximal end 725 interacting with retaining wall 607. In this manner, hinge 611 behaves as a spring-loaded hinge. In the depicted embodiment, hinge rod 733 is retained within hinge bracket 735 using a retainer pin 739, but other embodiments may comprise other retaining mechanisms without deviating from the teachings disclosed herein.

When an external load 750 is applied to shelf 750, the downward motion of shelf 605 effectively causes an outward rotation (i.e., “away” from the shelf) of cantilever 609 along rotational direction 737, resulting in a outward force of proximal end 725 in a direction 755 against the spring force applied by spring bolt 731. The spring force of spring bolt 731 returns proximal end 725 to a neutral position after the load has been removed.

When a sufficiently large force 755 is applied to spring bolt 731, the spring exhibits maximum compression, and no further displacement of cantilever 609 can be achieved. Advantageously, spring bolt 731 may have a greater threshold load value before its elastic behavior is affected compared to other designs, such as cantilever 209 (see FIG. 3) which relies upon a joint. Thus, cart 600 may advantageously be suitable for use with greater loads without any reduction in functionality because of reduced elasticity. By way of example, and not limitation, the threshold load value for cart 600 may be in the range of 40 to 60 pounds, and the threshold load value of each cantilever 609 may be in the range of 20 to 30 pounds without deviating from the teachings disclosed herein.

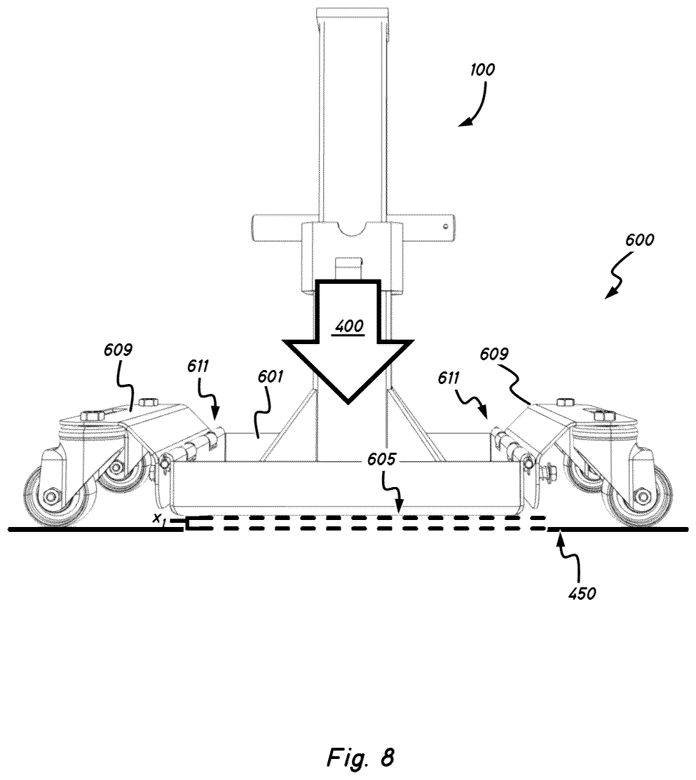

FIG. 8 is an illustration of cart 600 supporting jackstand 100. The weight of jackstand 100 applies a first load 400 to cart 600 that is received by shelf 601. Jackstand 100 is selected for its weight such that load 400 is less than the threshold load value of cart 600. As a result, there is a clearance distance x₁ between bottom surface 605 of cart 600 and the surface of the terrain 450 supporting cart 600. In the depicted embodiment, clearance distance x₁ is positive, but is not maximized. Clearance distance x₁ is maximized when cart 600 is subjected to zero external load. In response to loads greater than zero, shelf 601 lowers closer to terrain 450, and cantilevers 609 correspondingly rotate away from shelf 601 via the spring-loaded hinge 611 (see FIG. 7). This rotation be advantageously utilized to stabilize cart 600 under sufficiently heavy loads.

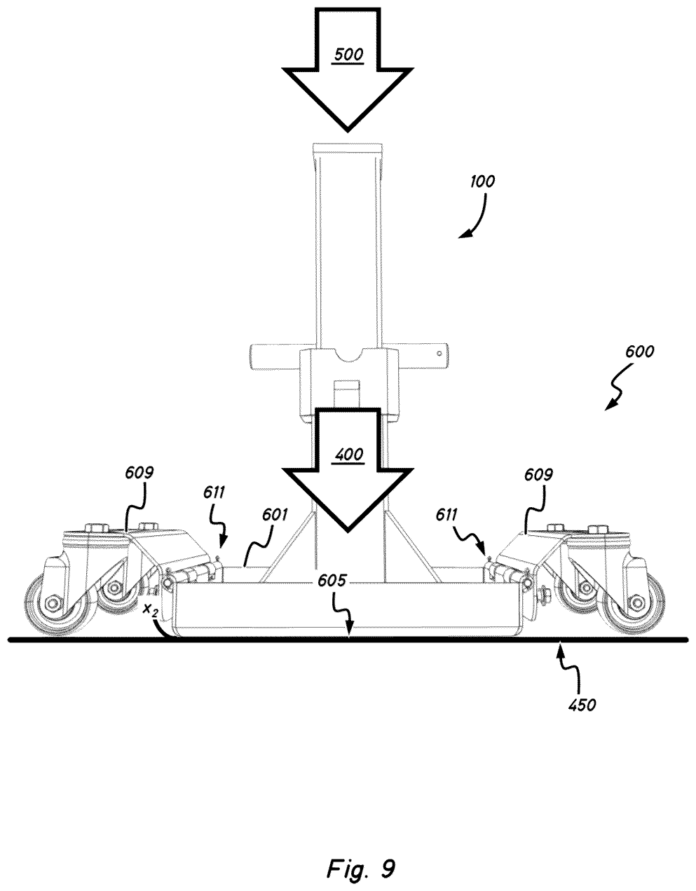

FIG. 9 is an illustration of jackstand 100 and cart 600 supporting additional load 500, such as the weight provided by an automobile (not shown) via support surface 113 (see FIG. 1). In the depicted embodiment, the combination of the load 400 from the weight of the jackstand and the additional load 500 is greater than the threshold load value of cart 600. As a result, the shelf 601 drops such that bottom surface 605 comes in contact with terrain 450. Consequently, the clearance distance x₂ is reduced to zero, and also each cantilever 209 is exhibiting maximum rotation. In the depicted embodiment, this results in each of wheels 211 losing contact with terrain 450, though in other embodiments wheels 211 may instead only receive a minimum portion of the overall load without deviating from the teachings herein. In this condition, the bulk of the combined force of loads 400 and 500 received by shelf 601 and transferred directly to terrain 450 via bottom surface 605. This transfer of the bulk of the load protects the elasticity of each of spring bolts 731 (see FIG. 7), which will thus advantageously not be subjected to loads that will plastically deform their shape. In this manner, once jackstand 100 is relieved of external load 500, the total load received by cart 600 will be under the threshold load value again, and cart 600 can advantageously be moved around using the wheels 211 again. This rotation of cantilevers 609 additional has the advantage of eliminating the ability of wheels 211 of moving during loads greater than the threshold load value for cart 200, and thus provides a secure and stable support of load 500 during the duration of time that the total lead exceeds the threshold load value. In the depicted embodiment, the threshold load value of cart 600 is selected to be only a small amount of force larger than load 400, thus only a small additional load is sufficient to cause the total load to be securely transferred to terrain 450 for safe operation of jackstand 100 while supported by cart 600.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A cart comprising:
a shelf having a top surface and a bottom surface, the top surface configured to receive a load and the bottom surface being disposed at a clearance distance over a terrain surface supporting the cart;
a cantilever having a proximal end and a distal end, the proximal end coupled to the shelf; and
a wheel coupled to the cantilever at the distal end,
wherein the shelf transfers a received load to the wheel via the cantilever, wherein the cantilever elastically deforms when subjected to the received load such that the clearance distance is correlated to the received load, wherein the clearance distance is maximized under zero load and the clearance distance is minimized when the load is greater than a threshold load value, and wherein the bottom surface is in contact with the terrain surface when the clearance distance is minimized.

2. The cart of claim 1, wherein the cantilever is one of a plurality of cantilevers and the wheel is one of a plurality of wheels, each of the plurality of wheels being coupled to one of the plurality of cantilevers.

3. The cart of claim 2, wherein the plurality of cantilevers comprises four cantilevers, and the plurality of wheels comprises four wheels.

4. The cart of claim 3, wherein the threshold load value of each of the four cantilevers is 10 to 13 pounds.

5. The cart of claim 1, wherein a length of a first dimension of the top surface is 10 to 16 inches.

6. The cart of claim 1, wherein the distal end is disposed at an angle to the proximal end.

7. The cart of claim 6, where the angle is a right angle under zero load.

8. The cart of claim 6, wherein the elasticity of the cantilever is expressed at a joint of the angle.

9. The cart of claim 1, wherein the distal end is coupled to the wheel via a stem of the wheel.

10. A cart comprising:
a shelf having a top surface and a bottom surface, the top surface configured to receive a load and the bottom surface being disposed at a clearance distance over a terrain surface supporting the cart;
a cantilever having a proximal end and a distal end, the proximal end coupled to the shelf via a spring-loaded hinge; and
a wheel coupled to the cantilever at the distal end,
wherein the shelf transfers a received load to the wheel via the cantilever, wherein the spring-loaded hinge compresses when subjected to a received load such that the clearance distance is correlated to the received load, wherein the clearance distance is maximized under zero load and the clearance distance is minimized when the load is greater than a threshold load value, and wherein the bottom surface is in contact with the terrain surface when the clearance distance is minimized.

11. The cart of claim 10, wherein the cantilever is one of a plurality of cantilevers.

12. The cart of claim 11, wherein the wheel is one of a plurality of wheels, each of the wheels coupled to one of the plurality of cantilevers.

13. The cart of claim 11, wherein the plurality of cantilevers comprises two cantilevers.

14. The cart of claim 13, wherein the wheel is one of four wheels, each of the cantilevers coupled to two wheels.

15. The cart of claim 14, wherein the threshold load value of each of the two cantilevers is 20 to 26 pounds.

16. The cart of claim 10, wherein a length of a first dimension of the shelf is 10 to 16 inches.

17. The cart of claim 10, wherein the distal end is disposed at an angle to the proximal end.

18. The cart of claim 10, wherein the elasticity of the cantilever is expressed at the spring-loaded hinge.

19. The cart of claim 10, wherein the spring of the spring-loaded hinge is coupled to the shelf, and the proximal end engages the spring.

20. The cart of claim 10, wherein the distal end is coupled to the wheel via a stem of the wheel.
